(19) United States
(12) Patent Application Publication
(10) Pub. No.: US 2025/0192333 A1
(43) Pub. Date: Jun. 12, 2025

(54) TRACTION BATTERY PACK HAVING CELL HOLDERS WITH MULTIPLE WALLS

(71) Applicant: Ford Global Technologies, LLC, Dearborn, MI (US)

(72) Inventors: Douglas Christian Lipp, Ann Arbor, MI (US); Alex Revels, Canton, MI (US); Karen Siler, Commerce Twp., MI (US); Jason C. Marcath, Dearborn, MI (US)

(21) Appl. No.: 18/914,421

(22) Filed: Oct. 14, 2024

Related U.S. Application Data
(60) Provisional application No. 63/607,888, filed on Dec. 8, 2023.

(51) Int. Cl. H01M 50/291; B60L 50/60; B60L 50/64; H01M 10/625; H01M 10/647; H01M 10/6554; H01M 50/211; H01M 50/249; H01M 50/264; H01M 50/293; H01M 50/502

(52) U.S. Cl. CPC H01M 50/291; B60L 50/64; H01M 10/625; H01M 10/647; H01M 10/6554; H01M 50/211; H01M 50/249; H01M 50/264; H01M 50/293; H01M 50/502; B60L 50/66; H01M 2220/20

(57) ABSTRACT

A traction battery pack system includes cell holders each having a plurality of walls. The cell holders are disposed along a cell stack axis. Battery cell groups are disposed along the cell stack axis and are each housed in one of the cell holders. The plurality of walls including an axially facing wall disposed between two of the battery cell groups. A tensioning member holds the plurality of cell holders along the cell stack axis.

### CROSS-REFERENCE TO RELATED APPLICATIONS

This disclosure claims priority to U.S. Provisional Application No. 63/607,888, which was filed on Dec. 8, 2023, and is incorporated herein by reference in its entirety.

### TECHNICAL FIELD

This disclosure relates generally to a cell holder that can hold a group of one or more battery cells within a traction battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack system, including: a plurality of cell holders each having a plurality of walls, the plurality of cell holders disposed along a cell stack axis; a plurality of battery cell groups disposed along the cell stack axis, each of the battery cell groups in the plurality of battery cell groups housed in one of the cell holders in the plurality of cell holders, the plurality of walls including an axially facing wall disposed between two of the battery cell groups in the plurality of battery cell groups; and a tensioning member that holds the plurality of cell holders along the cell stack axis.

In some aspects, the techniques described herein relate to a traction battery pack system, wherein each of the plurality of cell holders each include a top wall, a first lateral wall, and an opposite, second lateral wall.

In some aspects, the techniques described herein relate to a traction battery pack system, further including a thermal exchange plate, the plurality of cell holders and the plurality of battery cell groups disposed on the thermal exchange plate with the plurality of battery cell groups between the top walls of the plurality of battery cell holders and the thermal exchange plate.

In some aspects, the techniques described herein relate to a traction battery pack system, wherein the plurality of cell holders are polymer-based materials.

In some aspects, the techniques described herein relate to a traction battery pack system, wherein the plurality of cell holders each have four walls.

In some aspects, the techniques described herein relate to a traction battery pack system, wherein the plurality of cell holders are rectangular and have an open wall that faces axially.

In some aspects, the techniques described herein relate to a traction battery pack system, further including at least one busbar secured each of the cell holders in the plurality of cell holders.

In some aspects, the techniques described herein relate to a traction battery pack system, wherein the tensioning member is a tensioning rod.

In some aspects, the techniques described herein relate to a traction battery pack system, wherein the tensioning member is a tensioning band.

In some aspects, the techniques described herein relate to a traction battery pack system, wherein each of the battery cell groups in the plurality of battery cell groups contacts two cell holders within the plurality of cell holders.

In some aspects, the techniques described herein relate to a traction battery pack system, wherein each of the battery cell groups in the plurality of battery cell groups contacts axially facing walls of the two cell holders within the plurality of cell holders.

In some aspects, the techniques described herein relate to a traction battery pack system, wherein at least some of the cell holders in the plurality of cell holders are spaced from axially adjacent cell holders along the cell stack axis.

In some aspects, the techniques described herein relate to a traction battery pack system, wherein a distance between axially adjacent cell holders varies along the cell stack axis.

In some aspects, the techniques described herein relate to a traction battery pack system, wherein the plurality of battery cell groups are a plurality of pouch-style battery cell groups.

In some aspects, the techniques described herein relate to a traction battery pack system, wherein the plurality of cell holders and the plurality of battery cell groups are compressed along the cell stack axis.

In some aspects, the techniques described herein relate to a traction battery pack system, including: a plurality of cell holders disposed along a cell stack axis, the plurality of cell holders each having an axially facing wall, a first lateral wall, and a second lateral wall; at least one busbar associated with each cell holder, the at least one busbar mounted to the first lateral wall, the second lateral wall, or both; a battery cell group housed within each cell holder and disposed along the cell stack axis, the battery cell group having at least one terminal secured to the at least one busbar; and a tensioning member that holds the plurality of cell holders along the cell stack axis.

In some aspects, the techniques described herein relate to a traction battery pack system, further including a thermal exchange plate, the plurality of cell holders each open to the thermal exchange plate so that the battery cell group can interface directly with the thermal exchange plate.

In some aspects, the techniques described herein relate to a traction battery pack system, wherein the plurality of cell holders each include a top wall, the thermal exchange plate and the top wall on opposite sides of the battery cell group.

In some aspects, the techniques described herein relate to a traction battery pack system, wherein the at least one busbar includes a first busbar mounted to the first lateral wall and a second busbar mounted to the second lateral wall.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a perspective view of a cell stack from the battery pack of FIG. 2.

FIG. 4 illustrates a close-up view of an area of FIG. 3.

FIG. 5 illustrates an expanded view of a cell holder, busbar, and battery cell group from the cell stack of FIG. 3.

FIG. 6 illustrates the busbar of FIG. 5 secured to the cell holder, and the cell holder holding the battery cell group.

### DETAILED DESCRIPTION

This disclosure details exemplary cell holders used within a traction battery pack. Each of the cell holders can hold a group of one or more individual battery cells. The cell holders and battery cells can be arranged with other cell holders and groups of battery cells along a cell stack axis to provide a cell stack. The cell holders can help to, among other things, manage compression along the cell stack axis.

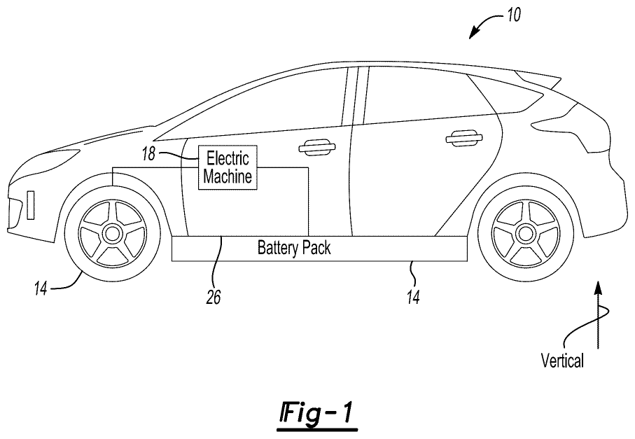

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

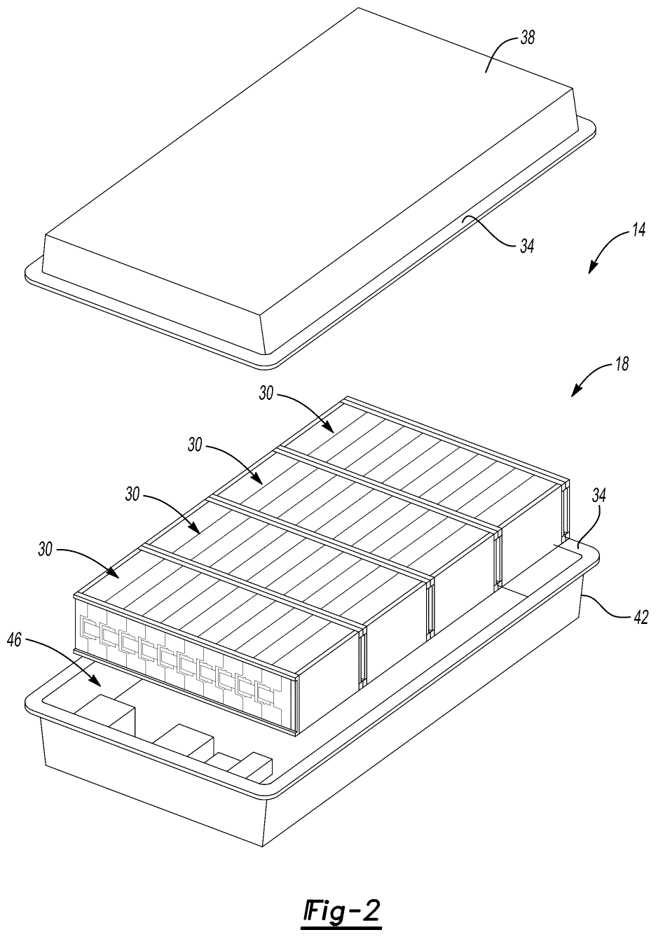

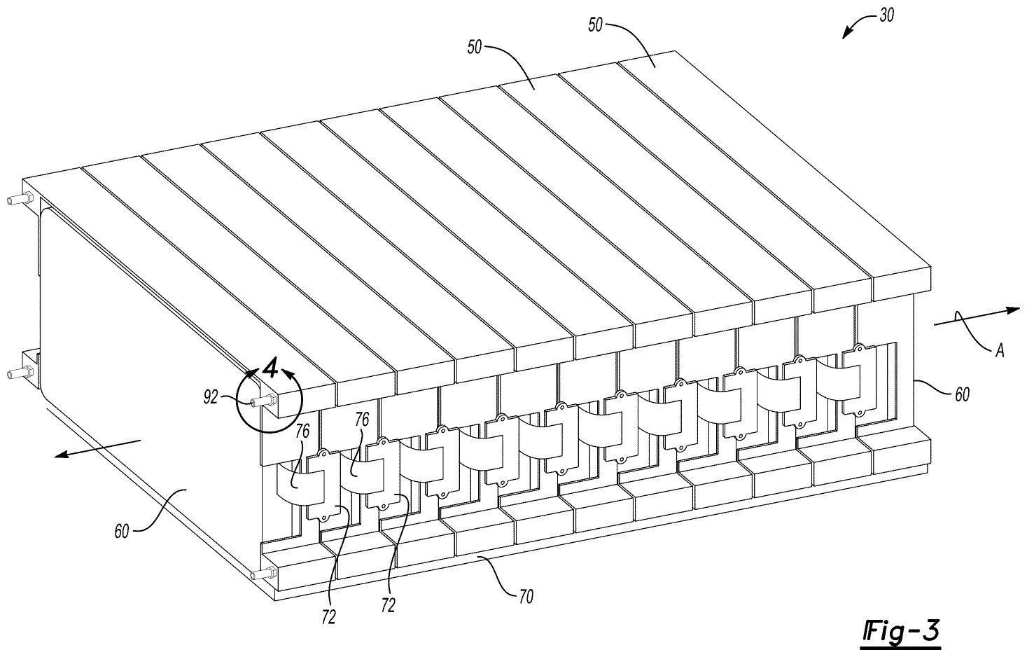

With reference to FIGS. 2 and 3, the battery pack 14 includes a plurality of cell stacks 30 held within an enclosure assembly 34. In the exemplary embodiment, the enclosure assembly 34 includes an enclosure cover 38 and an enclosure tray 42 that together provide an interior area 46 housing the cell stacks 30. The enclosure cover 38 can be secured to the enclosure tray 42 utilizing mechanical fasteners (not shown), for example.

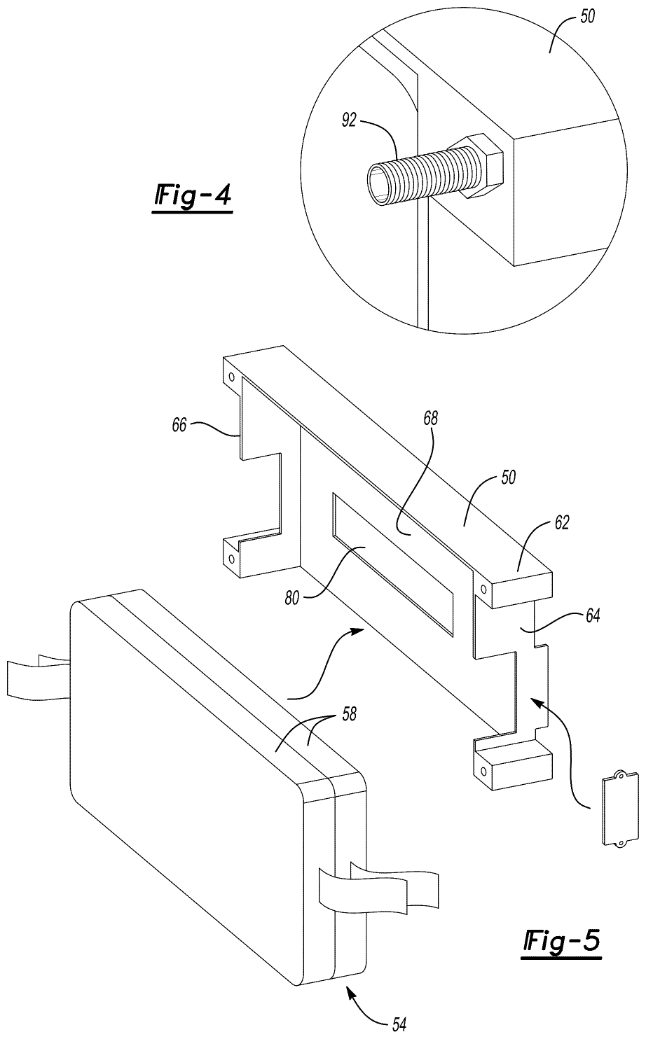

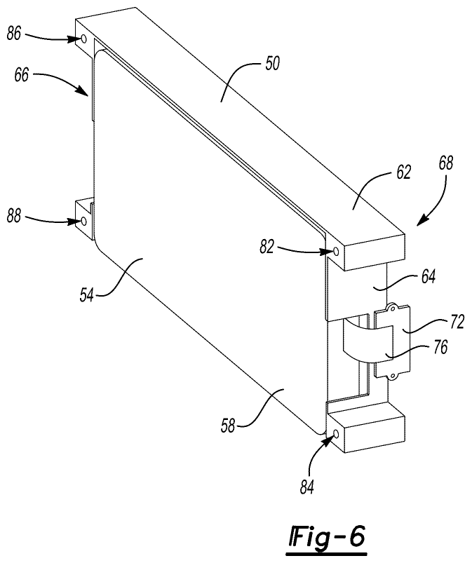

With reference now to FIGS. 4-6, and continuing reference to FIG. 2, the cell stacks 30 each include a plurality of cell holders 50 and cell groups 54 distributed along a cell stack axis A. Each of the cell groups 54 includes one or more individual battery cells 58. The cell groups 54 are each housed within one of the cell holders 50. The cell groups 54 and the cell holders 50 are compressed along the cell stack axis between endplates 60 in this example.

The cells 58 store and supply electrical power. Although a specific number of cells 58 and cell groups 54 are disclosed in this example, the battery pack could include any number of individual cells 58, cell groups 54, cell holders 50, and cell stacks 30. The cell groups 54 could each include four individual cells, for example.

In this embodiment, the battery cells 58 are lithium-ion pouch-style cells. However, battery cells having other configurations (cylindrical, prismatic, etc.), other chemistries (nickel metal hydride, lead acid, etc.), or both could be alternatively utilized within the scope of this disclosure.

The example cell holders 50 are rectangular and each include four distinct walls. In the exemplary embodiment, the walls of the cell holders 50 include a top wall 62, a first lateral wall 64, a second lateral wall 66, and a (single) axially facing wall 68. When positioned within the cell stack 30, the axially facing walls 68 of the cell holders 50 are each disposed between two of the cell groups 54. The top wall 62 extends horizontally from the axially facing wall 68 over the cell group 54. The top wall 62 is a vertically uppermost wall of the cell holder 50. Vertical, for purposes of this disclosure, is with reference to ground and a general orientation of the cell holder 50 when installed within the battery pack 14.

Within the interior area 46 of the enclosure assembly 34, the cell stacks 30 rest upon a thermal exchange plate 70. The cell holders 50 are arranged such that an open side of the cell holders 50 opens to the thermal exchange plate 70. Due to the open side that opens to the thermal exchange plate 70, the cell groups 54 received within the cell holder 50 can interface directly with the thermal exchange plate 70. In some examples, a thermal fin, thermal interface material, or another structure can be sandwiched between the cell groups 54 and the thermal exchange plate 70 to facilitate a transfer of thermal energy. The top wall 62 is on a side of the cell group 54 opposite the thermal exchange plate 70 in this example.

The first lateral wall 64 and the second lateral wall 66 face outward away from the cell stack axis A. A busbar 72 is mounted to the first lateral wall 64. Another busbar (not shown) is similarly mounted to the second lateral wall 66. The busbars 72 can be mounted to the respective first lateral walls 64 or second lateral wall 66 via heat stakes, for example. In another example, the busbars 72 slide within grooves provided by the cell holders 50.

The cells 58 each include tab terminals 76, which can extend out between the cell holders 50 to connect to the busbar 72 attached to the first lateral wall 64 or the busbar attached to the second lateral wall 66.

In this example, cell holders 50 are a polymer-based material in this example, such as a glass filled nylon. To secure a cell group 54 within one of the cell holders 50, a double-sided tape 80 or another adhesive could be used to bond the cell group 54 to at least the axially facing wall 68 of the respective cell holder 50.

Various other layers, such as foam layers, could be incorporated into the cell stack 30 between the cells 58, between the cell holders 50, between the cell holders 50 and the cells 58, or some combination of these.

In the exemplary embodiment, the first lateral wall 64 includes a first upper bore 82 and a first lower bore 84. The second lateral wall 66 includes a second upper bore 86 and a second lower bore 88. To secure the cell holders 50 with the cell groups 54 along the cell stack axis A, tensioning members 92 are placed within the first upper bores 82, the first lower bores 84, the second upper bores 86, and the second lower bores 88. The tensioning members 92 are tensioning rods in this example. In another example, the tensioning members 92 could be tensioning bands.

In an example, the cell holders 50 with the cell groups 54 can be assembled with a desired compressive load along the cell stack axis A. The cell holders 50 can be sized to be spaced from the axially adjacent cell holders 50 so that compressive loads along the cell stack axis A can be transferred through the cell groups 54 and the axially facing walls 68 of the cell holders 50. This can facilitate applying a desired compressive load to each cell group 54 allowing an assembler to, in some examples, alter a distance or gap between the cell holders 50 to achieve a desired compressive load on the cell groups 54. The distance between the cell holders 50 can vary along the cell stack axis. The cell holders 50 can be, in some examples, fixed at a particular axial position along the cell stack axis A. The cell holders 50 could be bonded to the tensioning members 92, the thermal exchange plate 70, or both to fix the cell holders 50 in a particular position.

In other examples, the cell holders 50 with the cell groups 54 are all assembled to the tensioning members 92 and then compressed together along the cell stack axis A. The cell holders 50 with the cell groups 54 may be permitted to float along the axis A and along the tensioning members 92. After applying a desired compressive load, the cell stack can be adhesively secured to the thermal exchange plate 70, the tensioning members 92, or both.

During a thermal event where one or more of the cells 58 is venting, the vented vent byproducts can be at least partially compartmentalized by the cell holders 50. Utilizing the cell holders 50 to block the flow of vent byproducts to other cells 58 that are not venting can help to block thermal energy from the vent byproducts heating the cells 58 that are not venting and causing those cells 58 to vent. The cell holders 50 can block axial movement of the vent byproducts and can force the vent byproducts outward from the cell stack axis A through gaps between the cell holders 50.

Features of some of the disclosed examples include provided a cell holder within a cell stack. The cell holder can help manage compressive loads on cells of the cell stack and, as required, vent byproducts vented from one or more the battery cells, the use of holders facilitates a modular design allowing a size of the cell stack to be increased or decreased by adding or removing cell holders and cells held within those holders. This concept can be used to allow some variation in spacing between cell holders, which can allow substantially uniform cell compression forces across the entire cell stack despite tolerances.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack system, comprising:
a plurality of cell holders each having a plurality of walls, the plurality of cell holders disposed along a cell stack axis;
a plurality of battery cell groups disposed along the cell stack axis, each of the battery cell groups in the plurality of battery cell groups housed in one of the cell holders in the plurality of cell holders, the plurality of walls including an axially facing wall disposed between two of the battery cell groups in the plurality of battery cell groups; and
a tensioning member that holds the plurality of cell holders along the cell stack axis.

2. The traction battery pack system of claim 1, wherein each of the plurality of cell holders each include a top wall, a first lateral wall, and an opposite, second lateral wall.

3. The traction battery pack system of claim 2, further comprising a thermal exchange plate, the plurality of cell holders and the plurality of battery cell groups disposed on the thermal exchange plate with the plurality of battery cell groups between the top walls of the plurality of battery cell holders and the thermal exchange plate.

4. The traction battery pack system of claim 1, wherein the plurality of cell holders are polymer-based materials.

5. The traction battery pack system of claim 1, wherein the plurality of cell holders each have four walls.

6. The traction battery pack system of claim 1, wherein the plurality of cell holders are rectangular and have an open wall that faces axially.

7. The traction battery pack system of claim 1, further comprising at least one busbar secured each of the cell holders in the plurality of cell holders.

8. The traction battery pack system of claim 1, wherein the tensioning member is a tensioning rod.

9. The traction battery pack system of claim 1, wherein the tensioning member is a tensioning band.

10. The traction battery pack system of claim 1, wherein each of the battery cell groups in the plurality of battery cell groups contacts two cell holders within the plurality of cell holders.

11. The traction battery pack system of claim 10, wherein each of the battery cell groups in the plurality of battery cell groups contacts axially facing walls of the two cell holders within the plurality of cell holders.

12. The traction battery pack system of claim 1, wherein at least some of the cell holders in the plurality of cell holders are spaced from axially adjacent cell holders along the cell stack axis.

13. The traction battery pack system of claim 1, wherein a distance between axially adjacent cell holders varies along the cell stack axis.

14. The traction battery pack system of claim 1, wherein the plurality of battery cell groups are a plurality of pouch-style battery cell groups.

15. The traction battery pack system of claim 1, wherein the plurality of cell holders and the plurality of battery cell groups are compressed along the cell stack axis.

16. A traction battery pack system, comprising:
a plurality of cell holders disposed along a cell stack axis, the plurality of cell holders each having an axially facing wall, a first lateral wall, and a second lateral wall;
at least one busbar associated with each cell holder, the at least one busbar mounted to the first lateral wall, the second lateral wall, or both;
a battery cell group housed within each cell holder and disposed along the cell stack axis, the battery cell group having at least one terminal secured to the at least one busbar; and
a tensioning member that holds the plurality of cell holders along the cell stack axis.

17. The traction battery pack system of claim 16, further comprising a thermal exchange plate, the plurality of cell holders each open to the thermal exchange plate so that the battery cell group can interface directly with the thermal exchange plate.

18. The traction battery pack system of claim 17, wherein the plurality of cell holders each include a top wall, the thermal exchange plate and the top wall on opposite sides of the battery cell group.

19. The traction battery pack system of claim 16, wherein the at least one busbar includes a first busbar mounted to the first lateral wall and a second busbar mounted to the second lateral wall.
